(19) United States
(12) Patent Application Publication
(10) Pub. No.: US 2011/0277532 A1
(43) Pub. Date: Nov. 17, 2011

(54) Method for calibrating an acceleration sensor and electronic device

(76) Inventors: Julian Bartholomeyczik, Reutlingen (DE); Sergej Scheiermann, Eningen (DE)

(21) Appl. No.: 13/068,199

(22) Filed: May 4, 2011

(30) Foreign Application Priority Data
May 11, 2010 (DE) 10 2010 028 827.6

(51) Int. Cl. G01P 21/00

(52) U.S. Cl. 73/1.38

(57) ABSTRACT

A method for calibrating an acceleration sensor includes the following sequential steps: ascertaining acceleration values as a function of three spatial directions; for each of the three spatial directions, generating a comparison value from the acceleration values; comparing each of the comparison values to a first threshold value; calculating a cumulative value as a function of at least one acceleration value for each of the three spatial directions; comparing the cumulative value to a second threshold value; and calibrating the acceleration sensor when, in the third method step, for each of the three spatial directions, the comparison value is less than the threshold value, and when, in the fifth method step, the cumulative value is greater than the further threshold value.

### BACKGROUND OF THE INVENTION

1. Field of the Invention

The present invention relates to a method for calibrating an acceleration sensor.

2. Field of the Invention

Methods of this kind are generally known. For example, printed German patent application document DE 10 2007 002 835 A1 describes a method for calibrating a yaw rate sensor system, in which calibration is carried out using inclination data from an acceleration sensor system. The acceleration sensor system also sends a calibration-initiating zero signal to the yaw-rate sensor system as soon as a resting state is detected, so that in each instance, the calibration of the yaw-rate sensor system is only carried out in the resting states.

However, this method is not suitable for calibrating acceleration sensors in portable devices by measuring gravitational acceleration in a resting state, i.e., a “1 g” state of the portable device, since in this case, in addition to the detection of the resting state (detection of the absence of accelerations, which are superimposed on the gravitational acceleration), the resting state must also be distinguished from “free-fall,” since in “free fall,” it is not possible to measure gravitational acceleration using only an acceleration sensor.

### BRIEF SUMMARY OF THE INVENTION

The method and the electronic device according to the present invention have the advantage over the related art that the presence of a resting state is detectable in a comparatively simple, energy-saving and efficient manner and therefore, a calibration of the acceleration sensor is only carried out in the presence of such a resting state. In the spirit of the present invention, a resting state (also denoted here as a “1 g” state) is, in particular, a state in which, in essence, only gravitational force (“1 g” acceleration, “g” standing for the acceleration due to gravity) is acting as an acceleration force and no “free fall” is present. For example, the portable device in which the acceleration sensor to be calibrated is situated lies stationary on a support surface such as a granite table plate. This has the advantage that the calibration of the acceleration sensor is carried out exclusively in the resting state and, in particular, not during the presence of other dominating acceleration forces, since a precise measurement of acceleration due to gravity is only possible in this case. In this context, the acceleration sensor is adjusted or calibrated, in particular, in light of the measurement of the known acceleration due to gravity. Therefore, both a calibration of an already pre-calibrated acceleration sensor and a calibration of a still uncalibrated acceleration sensor are rendered possible in an advantageous manner. This allows, for example, (post- and/or re-) calibration of the acceleration sensor during the use of a device in which the acceleration sensor is integrated. This is especially advantageous, in particular, in consumer products equipped with acceleration sensors, such as cellular phones, digital cameras, laptops, notebooks, PDA's (personal digital assistant), hand-held GPS devices, game consoles, input devices for game consoles/computers (mouse, joystick, game controller) and the like, since the method of the present invention may allow a complicated and cost-intensive (pre-) calibration of the acceleration sensor during manufacture or immediately after manufacture of the device to be dispensed with. In addition, the acceleration sensor is, in particular, a three-channel acceleration sensor, i.e., sensitive along the three spatial directions X, Y, Z. Alternatively, the acceleration sensor includes three individual, single-channel acceleration sensor units, which are oriented such that accelerations along each of the three spatial directions are detected by one of the acceleration sensor units. The acceleration sensor preferably includes a micromechanical acceleration sensor. The micromechanical acceleration sensor preferably includes a seismic weight, which is movably suspended with respect to a substrate, and whose deflection with respect to the substrate as a result, of inertial forces generated by external acceleration forces is measured capacitively (for example, using a finger-electrode and/or capacitor-plate set-up). The calibration of the acceleration sensor is used, in particular, for determining and possibly compensating for manufacturing-specific offsets and sensor sensitivities for each of the three spatial directions.

According to a preferred, specific embodiment, it is provided that in a first partial step of the sixth method step, for each of the three spatial directions, an average value is determined as a function of the respective acceleration values, the average values preferably being ascertained using a least squares method; and that in a second partial step of the six method step, the calibration of the acceleration sensor is carried out on the basis of the average values. Consequently, a pre-calibration (i.e., a rough adjustment) of the acceleration sensor is advantageously carried out. In this manner, it is ensured that subsequent, in particular, iterative method steps for post-calibration (i.e., for fine adjustment) of the acceleration sensor converge, and that consequently, the accuracy of the calibration is markedly increased. In addition, the computational expenditure, i.e., the number of required iteration steps, and thus, also the time required for these subsequent method steps, are reduced. On the basis of the ascertained average values, current offset values and sensory sensitivities are preferably ascertained for each spatial direction, and therefore, pre-calibration of the acceleration values is carried out.

According to a preferred embodiment, it is provided that in a third partial step of the sixth method step, a calibration of the acceleration sensor be carried out using an iterative approximation method, the iterative approximation method preferably being implemented as a function of the acceleration values and/or as a function of further acceleration values. Consequently, the accuracy of the calibration is successively increased in an advantageous manner, using the iterative approximation method. In this context, the iterative approximation method preferably includes a Kalman filter, a Newtonian approximation method and/or a method of least squares. In this context, for each spatial direction, the offset values and the sensor sensitivities are successively brought closer to the actual offset values and sensor sensitivities of the acceleration sensor, using the iterative approximation method.

According to a preferred embodiment, it is provided that in a fourth partial step of the sixth method step, a checking method be implemented, in which a sum of squares is calculated as a function of at least one further acceleration value for each of the three spatial directions, and in which the sum of squares is compared to a third threshold value. Consequently, the quality of the calibration is advantageously determined, which means that as a function of the comparison of the sum of squares and the third threshold value, it is decided if a further iteration step is necessary for improving the calibration or if the calibration method may be terminated at this point (when the calibration quality is sufficiently high).

According to a preferred embodiment, it is provided that the third and fourth partial steps be sequentially repeated until, in the fourth partial step, the sum of squares is less than the third threshold value; and/or, that in the fourth partial step, the sum of squares is compared to a fourth threshold value, the method preferably being restarted at the first method step when the sum of squares is greater than the fourth threshold value. The comparison of the sum of squares to the fourth threshold value advantageously gives the option of completely restarting the method of the present invention (this means that all of the offset values and sensor sensitivities ascertained up to this point are discarded), when a quality of the calibration is detected as overly poor. Consequently, the pre-calibration, i.e., the rough adjustment, is also carried out once more.

According to a preferred embodiment, it is provided that in the second method step, for each of the spatial directions, both a maximum value and a minimum value in the respective acceleration values be determined; for each of the three spatial directions, the comparison value being determined, in each case, as a difference of the respective minimum value and the respective maximum value of the corresponding spatial direction. In this manner, the comparison value may be ascertained in a particularly simple manner and is thereby a reliable criterion for determining the dynamics along the specific spatial direction. Such functionality is, in particular, implementable in hardware and/or software in a comparatively simple, space-saving, and energy-efficient manner. It is particularly preferably provided that the acceleration values for each spatial direction, i.e., in particular, an X, Y and Z spatial direction, be saved in a separate FIFO memory (first in, first out memory), that is, a plurality of X-movement values are stored in an X-FIFO memory, a plurality of Y-movement values are stored in a Y-FIFO memory and a plurality of Z-movement values are stored in a Z-FIFO memory. Subsequently, a maximum and a minimum value are determined in each FIFO memory, and after that, the specific differential value of these maximum and minimum values is determined for each of the three spatial directions X, Y and Z, so that an X comparison value, a Y comparison value and a Z comparison value are generated. These three comparison values are then individually compared to a common, first threshold value or, as an alternative, to a separate, respective, first threshold value for each spatial direction. If the first threshold value of each comparison value, or each first threshold value of the respective comparison value, is not reached, it is ensured that the acceleration sensor is not subjected to any external acceleration forces large enough to hereby render impossible the measurement of the gravitational acceleration. Consequently, the calibration of the acceleration sensor is carried out if it is ensured, in the fifth method step, that no “free fall” is present.

According to a preferred embodiment, it is provided that in the fourth method step, the cumulative value be constituted of a sum of, in each instance, an acceleration value for each of the three spatial directions; and/or that in the fourth method step, for each of the three spatial directions, an average acceleration value be calculated from the respective acceleration values, the cumulative value being calculated as a sum of the specific, average acceleration values for each of the three spatial directions. In the fourth method step, the cumulative value is calculated, in particular, as a sum of absolute values as a function of at least one acceleration value for each spatial direction. Only reduced acceleration forces act in the state of free fall, which means that using the third method step alone, the resting state cannot be distinguished from “free fall.” Now, with the aid of the fifth method step, the resting state is advantageously distinguishable from the state of “free fall,” since in the case of free fall, the sum of absolute values of the specific acceleration values is less than in the resting state, which means that a differentiation is rendered possible by a suitable choice of the second threshold value. Calculating the cumulative value as a function of average acceleration values now advantageously increases the reliability and the accuracy in distinguishing the resting state from “free fall” in a simple manner.

A preferred embodiment provides that for each spatial direction, acceleration values ascertained in the first method step and/or further acceleration values be compared to previously ascertained acceleration values; the newly ascertained acceleration values and/or further acceleration values, as well as acceleration values already ascertained beforehand, each being preferably rounded, and the newly ascertained acceleration values and/or further acceleration values then being discarded, in particular, when the rounded, newly ascertained acceleration values and/or further acceleration values essentially correspond to the rounded acceleration values ascertained beforehand, and/or when a particular number of rounded, previously ascertained acceleration values are present, which correspond to the rounded, newly ascertained acceleration values and/or further acceleration values. Therefore, it is advantageously determined if the newly ascertained acceleration values are present in a “cluster,” which is already occupied by acceleration values already ascertained beforehand. In other words, it is checked if there are already similar acceleration values among the acceleration values ascertained beforehand. This prevents acceleration values that are only the same or similar from being used for calibrating the acceleration sensor again, since such a calibration would not produce the desired calibration quality. The newly ascertained acceleration values are preferably rounded to produce a particular accuracy, for example, by dividing the acceleration values by second powers and comparing them to the already previously ascertained acceleration values rounded in the same manner. In particular, the above-mentioned rounding on the basis of 2nd powers may be implemented in hardware in a comparatively simple manner. Subsequently, the newly ascertained acceleration values are only then further used, when they are in an unoccupied “cluster” and/or only a particular number of acceleration values already ascertained beforehand are in the corresponding “cluster.” In an analogous manner, newly ascertained, further acceleration values are likewise rounded and compared to acceleration values already ascertained beforehand and rounded and/or to further acceleration values. This also prevents only the same or similar, further acceleration values from being used to calibrate the acceleration sensor again, since such a calibration would likewise not produce the desired calibration quality.

An electronic device having an acceleration sensor and an evaluation unit constitutes further subject matter of the present invention; the acceleration sensor being configured to ascertain acceleration values along three spatial directions; the evaluation unit being configured to generate, in each instance, a comparison value for each of the three spatial directions from the acceleration values, as well as to compare each of the comparison values to a first threshold value; the evaluation unit further being configured to generate a cumulative value as a function of at least one acceleration value for each of the three spatial directions, as well as to compare the cumulative value to a second threshold value; the evaluation unit being configured to calibrate the acceleration sensor, when, for each of the three spatial directions, the comparison value is less than the threshold value, as well as when the cumulative value is greater than the second threshold value. Thus, in an advantageous manner, the calibration of the acceleration sensor is only then carried out, when the electronic device is in the resting state. In addition, the electronic device is specially configured to implement the method according to the present invention. The electronic device includes, in particular, a cellular phone, digital camera, laptop, notebook, PDA (personal digital assistant), hand-held GPS device, game console, input device for game consoles/computers (mouse, joystick, game controller) and/or the like. The evaluation unit includes, in particular, a sensor logic circuit, which is preferably implemented in an ASIC and/or microcontroller and preferably has at least three FIFO memories.

### BRIEF DESCRIPTION OF THE DRAWINGS

FIG. 1 shows a schematic view of a system for implementing a method according to a first specific embodiment of the present invention.

FIG. 2 shows a schematic view of a method according to a first specific embodiment of the present invention.

FIG. 3 shows a schematic view of a method according to a second specific embodiment of the present invention.

### DETAILED DESCRIPTION OF THE INVENTION

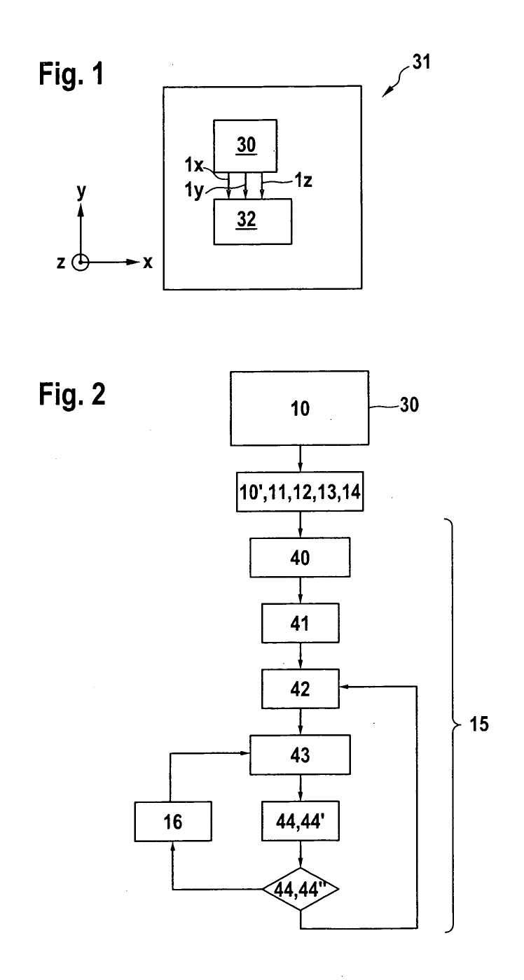

FIG. 1 shows a schematic view of an electronic device 31, which has an acceleration sensor 30, and in which a method for calibrating acceleration sensor 30 according to a first exemplary embodiment of the present invention is executed. Electronic device 31 includes, in particular, a mobile, portable device, such as a cellular phone. Electronic device 31 has the at least one acceleration sensor 30, as well as an evaluation unit 32. Acceleration sensor 30 includes a micromechanical, three-channel acceleration sensor, which is sensitive with respect to all three spatial directions X, Y, Z, i.e., measures accelerations along each of the three spatial directions X, Y, Z. The accelerations measured along each of the three spatial directions X, Y, Z are transmitted, in the form of acceleration values 1_{X}, 1_{Y}, 1_{Z} and sorted according to respective spatial direction X, Y, Z, to evaluation unit 32. With the aid of these acceleration values 1_{X}, 1_{Y}, 1_{Z}, evaluation unit 32 detects if electronic device 31 is in a resting state, and in the case that a resting state is present, the electronic device starts a calibration of acceleration sensor 30. In this context, acceleration sensor 30 is calibrated in view of the known gravitational acceleration, i.e., the so-called g vector. Should device 30 be subjected to sharp movements, however, the gravitational acceleration is superimposed by external accelerations that are caused by the sharp movements, which means that an exact calibration is not possible via measurement of the gravitational acceleration.

In the spirit of the present invention, a resting state (also referred to as a “1 g” state) is, in particular, a state in which, in essence, only the gravitational force (“1 g” acceleration, where “g” stands for the gravitational acceleration) acts as an acceleration force on system 1 and, in addition, no free fall is present. The calibration method is realized, in particular, using software and/or using additional logic circuitry implemented in hardware. Accordingly, evaluation unit 32 preferably includes an ASIC (made of, e.g., a digital part and an analog part), a microcontroller and/or a computer chip. The exact method of functioning of the calibration method is described in detail in the following, in particular, in view of FIGS. 2 and/or 3.

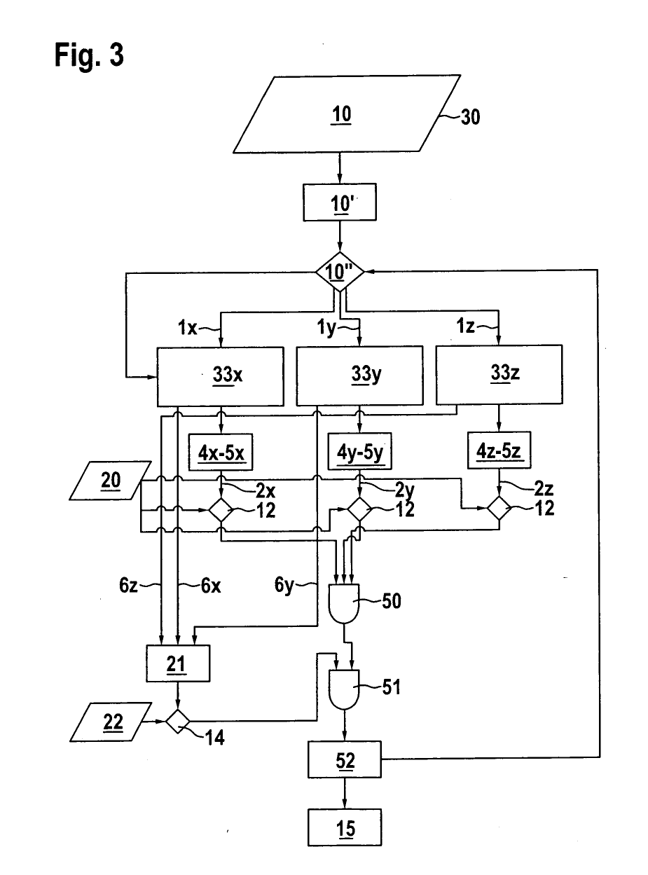

A schematic flow chart of a method according to a first specific embodiment of the present invention is illustrated in FIG. 2, this method being implemented, in particular, on an electronic device 31 illustrated with the aid of FIG. 1. In a first method step 10, acceleration values 1_{X}, 1_{Y}, 1_{Z} from, in particular, uncalibrated or only roughly pre-calibrated acceleration sensor 30 are ascertained as a function of accelerations along each of the three spatial directions X, Y, Z and transmitted to evaluation unit 32. In a “clustering” step 10′ of first method step 11, these newly ascertained acceleration values 1_{X}, 1_{Y}, 1_{Z} are further analyzed to determine if they are present in a “cluster,” which is already occupied by acceleration values 1_{X}, 1_{Y}, 1_{Z} previously ascertained beforehand. That is, it is determined if there are already similar acceleration values 1_{X}, 1_{Y}, 1_{Z} among the acceleration values 1_{X}, 1_{Y}, 1_{Z} already recorded beforehand. Newly ascertained acceleration values 1_{X}, 1_{Y}, 1_{Z} are rounded by dividing them by 2nd powers, and subsequently compared to acceleration values 1_{X}, 1_{Y}, 1_{Z} already ascertained beforehand and rounded in the same manner. Then, newly ascertained acceleration values 1_{X}, 1_{Y}, 1_{Z} are only further used, if they are in an unoccupied cluster and/or if, until now, only a predetermined number of similar acceleration values 1_{X}, 1_{Y}, 1_{Z} are situated in the corresponding cluster. Incidentally, such a “clustering” step is also executed, in particular, for all subsequently newly recorded, further acceleration values 1′_{X}, 1′_{Y}, 1′_{Z}. Afterwards, a “resting state detection” step in the form of a second, third, fourth and fifth method step 11, 12, 13, 14 is carried out; second and third method steps 12, 13 being used for dynamics detection, and fourth and fifth method steps 14, 15 being used for detecting a “free fall” (for details, see, in particular, in FIG. 3 and the corresponding figure description).

In second method step 11, for each of the three spatial directions X, Y, Z, a comparison value 2_{X}, 2_{Y}, 2_{Z} is ascertained from acceleration values 1_{X}, 1_{Y}, 1_{Z}; in third method step 12, each of comparison values 2_{X}, 2_{Y}, 2_{Z} being compared to a first threshold value 20. The first threshold value 20 not being reached by specific comparison value 2_{X}, 2_{Y}, 2_{Z} is a measure that no or only negligible dynamics are occurring along corresponding spatial direction X, Y, Z. A cumulative value 21 is further calculated in fourth method step 13, the addends of cumulative value 21 being formed as a function of at least one acceleration value 1_{X}, 1_{Y}, 1_{Z} for each of the three spatial directions X, Y, Z. Cumulative value 21 is therefore preferably proportional to the vector sum of specific acceleration values 1_{X}, 1_{Y}, 1_{Z}. In fifth method step 14, cumulative value 21 is subsequently compared to a second threshold value 22, in order to distinguish the resting state from the state of “free fall.” Second threshold value 22 is preferably greater than 0.2 g, particularly preferably greater than 0.5 g and especially preferably greater than 0.6 g, where g is the acceleration due to gravity.

Provided that, in third method step 12, for each of the three spatial directions X, Y, Z, comparison value 2_{X}, 2_{Y}, 2_{Z} is less than threshold value 20, and at the same time, in fifth method step 14, cumulative value 21 is greater than second threshold value 22, a calibration of acceleration sensor 30 is carried out in a subsequent, sixth method step 15. In this context, sixth method step 15 includes a first partial step 40; for each of the three spatial directions X, Y, Z, an average value 3_{X}, 3_{Y}, 3_{Z} preferably being calculated from acceleration values 1_{X}, 1_{Y}, 1_{Z}, using the method of least squares. In a second partial step 41 of sixth method step 15, a pre-calibration, i.e., a rough adjustment, of acceleration sensor 30 is subsequently carried out on the basis of average values 3_{X}, 3_{Y}, 3_{Z}; at this point, the sensor offset and the sensor sensitivity being determined for each of the three spatial directions X, Y, Z. After that, in a second partial step 42 of sixth method step 15, an iterative approximation method for post-calibrating, i.e., finely adjusting, acceleration sensor 30 is carried out. The iterative approximation method preferably includes a Kalman filter and is carried out on the basis of previously ascertained acceleration values 1_{X}, 1_{Y}, 1_{Z} and/or preferably on the basis of further acceleration values 1′_{X}, 1′_{Y}, 1′_{Z}.

Further acceleration values 1′_{X}, 1′_{Y}, 1′_{Z} are ascertained in an intermediate step 43 of sixth method step 15; analogously to above-mentioned acceleration values 1_{X}, 1_{Y}, 1_{Z}, further acceleration values 1′_{X}, 1′_{Y}, 1′_{Z} each preferably also having to successfully pass through the “clustering” step and the “resting-state detection” step beforehand. Now, on the basis of these further acceleration values 1′_{X}, 1′_{Y}, 1′_{Z}, a checking method is executed in a fourth partial step 44 of sixth method step 15; in the checking method, in a first sub-step 44′, a sum of squares 23 being calculated as a function of at least a further acceleration value 1′_{X}, 1′_{Y}, 1′_{Z}, and in a second sub-step 44″, this sum of squares 23 being compared to a third threshold value 24. For further understanding: in this checking step, it is particularly checked if, in the resting state of acceleration sensor 30, the vector sum of a further acceleration value 1′_{X}, 1′_{Y}, 1′_{Z} for each of the three spatial directions X, Y, Z, respectively, is close to the 1 g vector.

If sum of squares 23 exceeds third threshold value 24, then the quality of calibration is not yet sufficient, and third partial step 42 is executed once more to improve the quality of calibration. As an option, in the checking method, sum of squares 23 is even compared to a fourth threshold value 25 as well, which is greater than third threshold value 24. If fourth threshold value 25 is also exceeded by sum of squares 23, it is assumed that the previously executed sensor calibration is exceedingly poor, which means that the method of the present invention is completely restarted (otherwise, there is the risk of the iterative approximation method not converging). In this instance, the sensor offsets and sensor sensitivities already ascertained are discarded.

If sum of squares 23 is less than fourth threshold value 24, then, in a seventh method step 16, the method goes into a holding loop. After a run-off of a particular predefined period of time, which is preferably automatically set as a function of the difference of sum of squares 23 and fourth threshold value 24, intermediate step 43, as well as the checking method, are repeated in order to ensure permanent monitoring of the calibration quality of acceleration sensor 30 during use. Sum of squares 23 is calculated, for example, as (1_{X})²+(1_{Y})²+(1_{Z})². As an alternative, it is conceivable to use the sum of (1−sqrt[(1_{X})²+(1_{Y})²+(1_{Z})²])² for determining the calibration quality.

FIG. 3 shows a schematic flow chart of a method for calibrating an acceleration sensor 30 according to a second specific embodiment of the present invention, the second specific embodiment being substantially identical to the first specific embodiment illustrated in FIG. 2. In first method step 10, acceleration values 1_{X}, 1_{Y}, 1_{Z} are generated, which are a measure of accelerations of acceleration sensor 30 along the three spatial directions X, Y, Z. In a first “clustering step” 10′, these newly ascertained acceleration values 1_{X}, 1_{Y}, 1_{Z} are rounded, and in a second “clustering” step 10″, rounded, newly ascertained acceleration values 1_{X}, 1_{Y}, 1_{Z} are checked to determine if they are in a “cluster” that is already occupied by rounded acceleration values 1_{X}, 1_{Y}, 1_{Z} already ascertained beforehand. Acceleration values 1_{X}, 1_{Y}, 1_{Z} are then sorted according to respective spatial direction X, Y, Z in one of three FIFO memories 33_{X}, 33_{Y}, 33_{Z} of evaluation unit 3. In second method step 11, both maximum value 4_{X}, 4_{Y}, 4_{Z}, and minimum value 5_{X}, 5_{Y}, 5_{Z} for each of the three spatial directions X, Y, Z are then ascertained in each of FIFO memories 33_{X}, 33_{Y}, 33_{Z}, and subsequently, for each of the three spatial directions X, Y, Z, comparison value 2_{X}, 2_{Y}, 2_{Z} is determined, which is calculated from the mathematical difference of respective maximum value 4_{X}, 4_{Y}, 4_{Z} and respective minimum value 5_{X}, 5_{Y}, 5_{Z} of corresponding spatial direction X, Y, Z. In a subsequent, third method step 12, the three comparison values 2_{X}, 2_{Y}, 2_{Z} are each compared to first threshold value 20 (at this point, it is conceivable that when all three comparison values 2_{X}, 2_{Y}, 2_{Z} are each less than first threshold value 20, sixth method step 15 is already immediately started without even having executed fourth and fifth method steps 13, 14 beforehand).

In a subsequent auxiliary step 50, it is checked, with the aid of a logical AND gate, if all three comparison values 2_{X}, 2_{Y}, 2_{Z} are each less than first threshold value 20. Concurrently to this, for each FIFO memory 33_{X}, 33_{Y}, 33_{Z}, an average acceleration value 6_{X}, 6_{Y}, 6_{Z} is initially calculated from respective acceleration values 1_{X}, 1_{Y}, 1_{Z} for each of the three spatial directions X, Y, Z, and in a fourth method step 13, cumulative value 21 is then calculated from the three average acceleration values 6_{X}, 6_{Y}, 6_{Z} (|6_{X}|+|6_{Y}|+|6_{Z}|). Alternatively, it is also conceivable for cumulative value 21 to be calculated, in each instance, from a single acceleration value 1_{X}, 1_{Y}, 1_{Z} per spatial direction X, Y, Z, i.e., without calculating an average value (|1*_{X}|+|1*_{Y}|+|1*_{Z}|) (in this case, for example, the last acceleration value 1_{X}, 1_{Y}, 1_{Z} in respective FIFO memory 33_{X}, 33_{Y}, 33_{Z} is always used). In fifth method step 14, it is now checked if second threshold value 22 is exceeded by cumulative value 21.

In a subsequent, further auxiliary step 51, it is checked, with the aid of a further logical AND gate, if both second threshold value 22 is exceeded by cumulative value 21 and all three comparison values 2_{X}, 2_{Y}, 2_{Z} are each less than first threshold value 20. Only when these two conditions are satisfied, are acceleration values 1_{X}, 1_{Y}, 1_{Z} written into a data cluster 52 and, in a sixth method step 15, a calibration of acceleration sensor 30 carried out (provided enough acceleration values 1_{X}, 1_{Y}, 1_{Z} are present). Due to the two mathematical conditions, it is ensured that, on one hand, the resting state is distinguished from free fall (fifth method step 14) and that, on the other hand, the maximum allowed dynamics of acceleration sensor 30 in the resting state are limited for individual spatial directions X, Y, Z (third method step 12). In a further, first “clustering step” 10′, rounded, newly ascertained, further acceleration values 1′_{X}, 1′_{Y}, 1′_{Z} are then compared to these acceleration values 1_{X}, 1_{Y}, 1_{Z} currently written into data cluster 52 and checked to determine if they are in one and the same “cluster.”

What is claimed is:

1. A method for calibrating an acceleration sensor, comprising:
in a first method step, ascertaining acceleration values along three spatial directions;
in a second method step, for each of the three spatial directions, generating a comparison value from the corresponding acceleration values;
in a third method step, comparing each of the comparison values to a first threshold value;
in a fourth method step, calculating a cumulative value as a function of the acceleration values for the three spatial directions;
in a fifth method step, comparing the cumulative value to a second threshold value; and
in a sixth method step, calibrating the acceleration sensor if: (i) in the third method step, each of the comparison values for the three spatial directions is less than the first threshold value; and (ii) in the fifth method step, the cumulative value is greater than the second threshold value.

2. The method as recited in claim 1, wherein the sixth method step includes:
a first sub-step of determining, for each of the three spatial directions, a respective average value as a function of the respective acceleration values, the respective average value being determined using a method of least squares; and
a second sub-step of calibrating the acceleration sensor on the basis of the average values.

3. The method as recited in claim 2, wherein the sixth method step further includes:
a third sub-step of calibrating the acceleration sensor using an iterative approximation method as a function of the acceleration values.

4. The method as recited in claim 3, wherein the iterative approximation method in the third sub-step is carried out in the form of at least one of a Kalman filter, a Newtonian approximation method, and a method of least squares.

5. The method as recited in claim 4, wherein the sixth method step further includes:
a fourth sub-step of performing a checking method, wherein the checking method includes (i) for each of the three spatial directions, calculating a sum of squares as a function of at least one further acceleration value, and (ii) comparing the sum of squares to a third threshold value.

6. The method as recited in claim 5, wherein the third and fourth sub-steps are sequentially repeated until at least one of (i) in the fourth sub-step, the sum of squares is less than the third threshold value, and (ii) in the fourth sub-step, the sum of squares is compared to a fourth threshold value, the method being restarted at the first method step if the sum of squares is greater than the fourth threshold value.

7. The method as recited in claim 1, wherein in the second method step, for each of the three spatial directions, the following are performed:
both a maximum value and a minimum value are determined in the respective acceleration values; and
the comparison value is determined as a difference of the respective minimum value and the respective maximum value of the corresponding spatial direction.

8. The method as recited in claim 1, wherein in the fourth method step, for each of the three spatial directions, an average acceleration value is calculated from the respective acceleration values, and the cumulative value is calculated as a sum of the specific average acceleration values for each of the three spatial directions.

9. The method as recited in claim 1, wherein:
the acceleration values ascertained in the first method step for each spatial direction are compared to corresponding acceleration values for each spatial direction ascertained previously; and
the acceleration values ascertained in the first method step are discarded if at least one of (i) the acceleration values ascertained in the first method step essentially correspond to the acceleration values ascertained previously, and (ii) a predetermined number of the acceleration values previously determined correspond to the acceleration values determined in the first method step.

10. An electronic device, comprising:
an acceleration sensor configured to ascertain acceleration values along three spatial directions; and
an evaluation unit configured to:
generate, for each of the three spatial directions, a comparison value from the corresponding acceleration values;
compare each of the comparison values to a first threshold value;
calculate a cumulative value as a function of the acceleration values for the three spatial directions;
compare the cumulative value to a second threshold value; and
calibrate the acceleration sensor if: (i) each of the comparison values for the three spatial directions is less than the first threshold value; and (ii) the cumulative value is greater than the second threshold value.
